(19) United States
(12) Patent Application Publication
(10) Pub. No.: US 2023/0179516 A1
(43) Pub. Date: Jun. 8, 2023

(54) ROUTER DEVICE, PACKET TRANSFER METHOD AND PACKET TRANSFER PROGRAM

(71) Applicant: NIPPON TELEGRAPH AND TELEPHONE CORPORATION, Tokyo (JP)

(72) Inventors: Junki ICHIKAWA, Musashino-shi, Tokyo (JP); Hirokazu TAKAHASHI, Musashino-shi, Tokyo (JP); Toru MANO, Musashino-shi, Tokyo (JP); Tomoya HIBI, Musashino-shi, Tokyo (JP)

(73) Assignee: NIPPON TELEGRAPH AND TELEPHONE CORPORATION, Tokyo (JP)

(21) Appl. No.: 17/912,558

(22) PCT Filed: Mar. 24, 2020
(86) PCT No.: PCT/JP2020/012937

§ 371 Date: Sep. 19, 2022

(51) Int. Cl. H04L 45/58

(52) U.S. Cl. CPC H04L 45/58

(57) ABSTRACT

It is an object of the present disclosure to render each module easily replaceable and facilitate construction of a system in which an existing application has been incorporated. The present disclosure provides a router device including: a routing module that performs a routing process on a packet; a functional module that executes any operation on the packet subjected to the routing process performed by the routing module; and a config module that sets a communication path that connects between the routing module and the functional module.

### TECHNICAL FIELD

The present disclosure relates to a system for transferring a packet.

### BACKGROUND ART

An ordinary router has a function of referencing a routing table in accordance with the destination IP (Internet Protocol) address of a packet that has arrived and delivering the packet from an appropriate interface. In a system that requires advanced networking, meanwhile, it is occasionally requested to rewrite a packet header in conjunction with an application layer, or duplicate and encapsulate a packet itself.

Routing can be performed on the basis of a plurality of pieces of information (5-tuple) in the packet header, such as a source IP address and a port number, by using a technique called “PBR” (Policy-Based Routing).

### CITATION LIST

### Patent Literature

[PTL 1] U.S. Pat. No. 5,519,704 (Reliable transport protocol for internetwork routing)
[PTL 2] US2009/0323681 (Policy-based routing in a multi-homed computer)

### SUMMARY OF THE INVENTION

### Technical Problem

The PBR only allows routing and discard of a packet that matches the 5-tuple, and does not support rewriting of the header. It takes a development cost to add a new networking function to a router, and it depends on the use case whether such a special packet operation should be executed before routing (pre-routing) or after routing (post-routing).

It is an object of the present disclosure to provide a router device including routing function means for routing and transmitting a received packet and functional means for executing a desired operation on the packet, in which a new networking function can be added easily.

### Means for Solving the Problem

The present disclosure provides a router device including routing means for routing and transmitting a received packet and functional means for executing a desired operation on the packet, in which each of the means is modularized and a virtual interface or a memory is provided as a communication path between the modularized routing means and the modularized functional means.

Specifically, the present disclosure provides a router device including:
a routing module that performs a routing process on a packet;
a functional module that executes any operation on the packet subjected to the routing process performed by the routing module; and
a config module that sets a communication path that connects between the routing module and the functional module.

Specifically, the present disclosure provides a packet transfer method including:
setting a communication path, using a config module, that connects between a routing module and a functional module;
performing a routing process using the routing module on a packet that has flowed into a router device;
executing any operation using the functional module on the packet that has flowed into the router device; and
forwarding the packet between the routing module and the functional module using the communication path.

Specifically, the packet transfer program according to the present disclosure is a program for causing a computer to implement functions of the router device according to the present disclosure, and a program for causing a computer to execute steps of the packet transfer method according to the present disclosure.

### Effects of the Invention

With the present disclosure, in which a communication path is determined for each module, it is possible to flexibly remove and replace each module. Therefore, with the present disclosure, it is possible to provide a router device including routing function means for routing and transmitting a received packet and functional means for executing a desired operation on the packet, in which each module is easily replaceable to facilitate construction of a system to which a new networking function is added.

### BRIEF DESCRIPTION OF DRAWINGS

FIG. 1 illustrates an example of the configuration of a physical router.

FIG. 2 illustrates an example of the configuration of a common software router.

FIG. 3 illustrates an example of the configuration of a module-type router system according to the present disclosure.

FIG. 4 illustrates examples of connection by way of virtual/physical interfaces, in which FIG. 4(a) illustrates an example of development of a functional module on a virtual machine, FIG. 4(b) illustrates an example of development of a functional module on a container, and FIG. 4(c) illustrates an example of development of modules on a plurality of hosts.

FIG. 5 illustrates examples of connection by way of a memory, in which FIG. 5(a) illustrates an example of development of functional modules on an identical host and FIG. 5(b) illustrates an example of development of modules on a plurality of hosts.

FIG. 6 illustrates an example of the configuration for pre-routing.

FIG. 7 illustrates an example of the configuration for post-routing.

FIG. 8 illustrates an example of the configuration for intra-routing.

### DESCRIPTION OF EMBODIMENTS

An embodiment of the present disclosure will be described in detail below with reference to the drawings. The present disclosure is not limited to the embodiment described below. The embodiment is merely illustrative, and the present disclosure can be implemented with a variety of modifications and improvements made thereto on the basis of the knowledge of a person skilled in the art. The same reference signs in the specification and the drawings denote identical constituent elements.

(Configuration of Related Art)

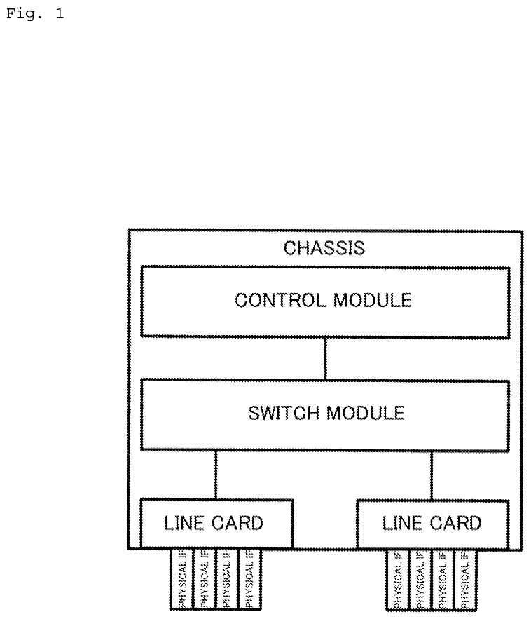

FIG. 1 illustrates an example of the configuration of a physical router. A physical router (ASIC: Application Specific Integrated Circuit) is an integral system in which the data plane and the control plane are constituted monolithically. It is necessary to additionally develop a new module that conforms to the standard or replace a physical module, in order to add a function or change the configuration.

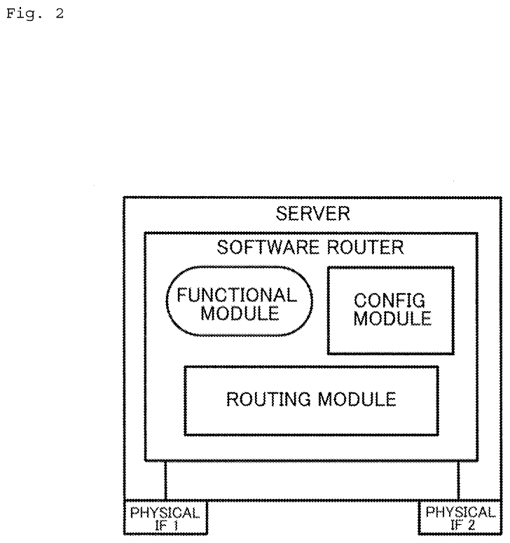

FIG. 2 illustrates an example of the configuration of a common software router. The common software router includes, in software, a config module and a functional module as a part of components. It is basically not possible to remove or replace a part of the components, and it is necessary to update the whole software in order to add a function or change the configuration.

(Point of the Disclosure)

In order to enhance the networking function of the router according to the related art, it is necessary to additionally develop a monolithic router system, which requires a cost and a time. Thus, the present disclosure proposes a module-type router system constituted from a routing module, a functional module, and a config module.

By adopting such a module-type router system, the present disclosure can implement a router system that has a desired function by incorporating an existing application function. The present disclosure can also configure a multi-function router system that can operate a packet at a timing desired by a user, without the need for additional development, by incorporating existing packet operation software and a software router.

(Configuration of the Disclosure)

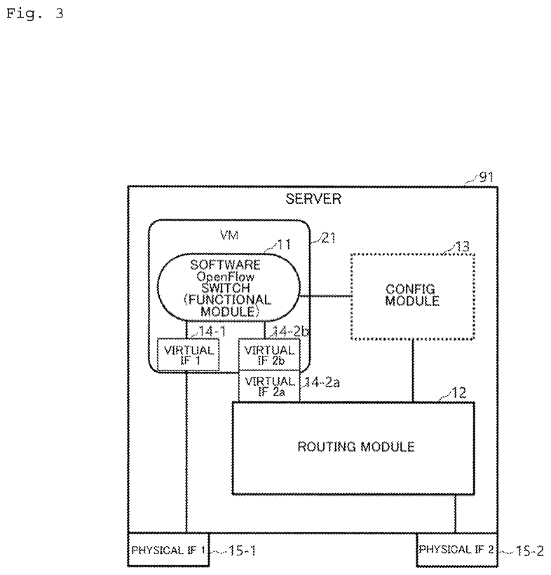

FIG. 3 illustrates an example of the configuration of a module-type router system according to the present disclosure. In the module-type router system according to the present disclosure, the following three modules are incorporated to constitute one router system.

Routing Module 12

A routing module 12 is a module that performs a routing process for L2 and L3 of an OSI (Open System Interconnection) reference model, in which a packet is received, a NextHop of the packet is determined in accordance with a routing table, and the packet is transmitted from an appropriate interface with the header rewritten.

### Example: Software Router

Functional Module 11

A functional module 11 is a module that executes any operation desired to be performed on a packet, which is not necessarily ordinary routing. Examples of such an operation include any process for L4 or higher of the OSI reference model, and may be 5-tuple match action for a packet by OpenFlow, in-line security protection by IPS, provision of a CDN (Content Delivery Network) by a cache server, etc. The match action for a packet includes a process that matches the source IP, the source port number, the destination IP, the destination port number, and the protocol number of the packet.

### Example: Software OpenFlow Switch

Config Module 13

A config module 13 is a module that integrally configures the routing module 12 and the functional module 11.

### Example: Openconfigd (Control Path by gRPC (RPC: Remote Procedure Call))

FIG. 3 illustrates an example of the configuration of a router device, in which the routing module 12, the functional module 11, and the config module 13 are provided in one device. The device according to the present disclosure can also be implemented by a computer and a program, and the program can be stored in a storage medium or provided through a network.

The routing module 12, the functional module 11, and the config module 13 may be developed on one or a plurality of physical servers. The modules may operate in either of a host environment provided in a physical server such as a host OS or a virtual environment configured on a physical server such as a virtual machine or a container. In the present disclosure, the virtual machine is occasionally abbreviated as “VM” (Virtual Machine).

Each communication path between the modules may be a virtual interface or a memory, for example. The communication path between the modules may be implemented by any of transmission and reception by way of physical/virtual interfaces and direct reference of the memory. In the present disclosure, the interface is occasionally abbreviated as “IF” (interface).

The module-type router system according to the present disclosure enables flexible removal and replacement of each module by opening the constituent elements of the software router according to the related art and determining a communication path for each module. The config module 13 and the functional module 11 make any processing configurable when the specifications of the communication path for the routing module 12 are met.

The order of connection between the routing module 12 and the functional module 11 includes the following three patterns.
pre-routing: a packet passes through the functional module 11 before routing by the routing module 12.
intra-routing: a packet passes to and returns from the functional module 11 during an interim of routing by the routing module 12.
post-routing: a packet passes through the functional module 11 after routing by the routing module 12.

A packet forwarding flow for a case where an OpenFlow module is used for the functional module 11 will be described as an exemplary embodiment. The module-type router system illustrated in FIG. 3 includes the following components, for example.

Functional module 11: software OpenFlow switch

Number of hosts: 1

Module development location: host for the routing module 11, host for the config module 13, and virtual machine for the functional module 12.

Communication Path: Virtual Interface

Function Connection Order: Pre-Routing

The OpenFlow switch module receives a packet from a communication path connected to a physical IF 15-1, executes an OpenFlow process, and thereafter returns the packet to a communication path connected to the routing module 12. The config module 13 serves as an OpenFlow controller, and reflects set flow rules and handles a packet inflow and a packet outflow.

The user configures the entire routing system for the config module 13. For example, the user of the present router system makes the following settings for the config module 13.

Setting 1: setting of the routing module 12
Assignment and address setting of physical IFs and virtual IFs controlled by the routing module 12

Setting 2: setting of the functional module 11
Assignment of virtual IFs controlled by the software OpenFlow switch
Flow setting of the software OpenFlow switch

The routing module 12 and the functional module 11 configure settings by reading settings from the config module 13 and reflecting the settings in the modules themselves at the time of system start-up.

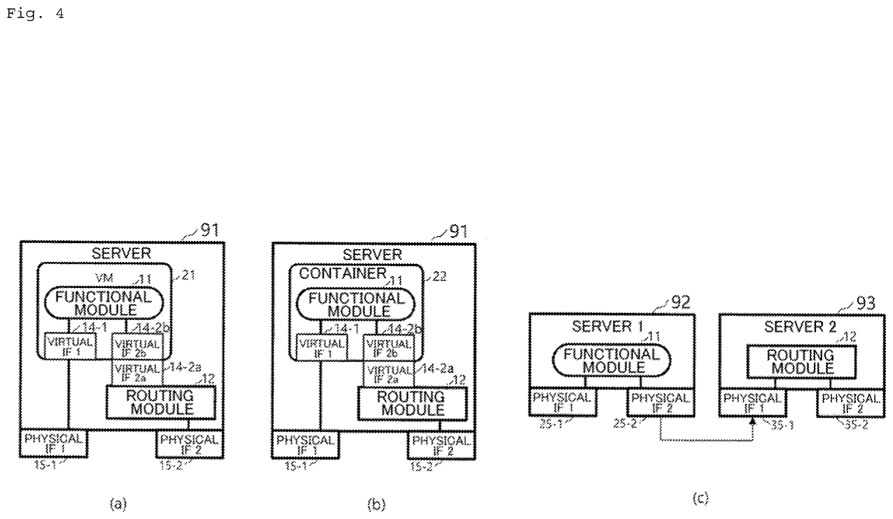

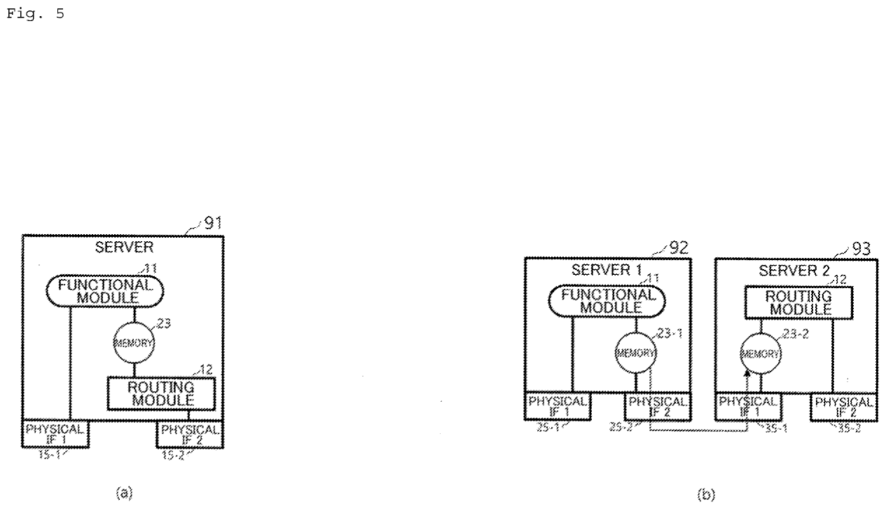

FIGS. 4 and 5 illustrate examples of the configuration of the routing module 12 and the functional module 11. While all the examples adopt pre-routing, intra-routing and post-routing may also be adopted similarly. While the config module 13 is not illustrated, the config module 13 is operable in any environment with a host, a virtual machine, or a container, and is also operable in an environment with a plurality of hosts.

FIG. 4 illustrates examples of connection by way of virtual/physical interfaces. In FIGS. 4(a) and 4(b), the routing module 12 and the functional module 11 are constructed on a common host. In FIG. 4(a), the functional module 11 is developed on a virtual machine 21. In FIG. 4(b), the functional module 11 is developed on a container 22.

Specifically, the virtual machine 21 and the container 22 include virtual IFs 14-11 and 14-2b, and the routing module 12 includes a virtual IF 14-2a. The virtual IF 14-1 is connected to the physical IF 15-1, and the virtual IF 14-2b is connected to the virtual IF 14-2a. The routing module 12 is connected to a physical IF 15-2. The routing module 12 and the functional module 11 forward a packet by way of the virtual IF 14-2b and the virtual IF 14-2a.

In FIG. 4(c), the functional module 11 and the routing module 12 are developed on a plurality of hosts. Specifically, a server 92 includes the functional module 11 and physical IFs 25-1 and 25-2, and a server 93 includes the routing module 12 and physical IFs 35-1 and 35-2. The functional module 11 and the routing module 12 forward a packet by way of the physical IFs 25-2 and 35-1.

FIG. 5 illustrates examples of connection by way of a memory. In FIG. 5(a), the modules are developed on an identical host. In FIG. 5(b), the functional module 11 and the routing module 12 are developed on a plurality of hosts.

Specifically, in the configuration in FIG. 5(a), the server 91 includes a memory 23, and the functional module 11 and the routing module 12 are connected to the memory 23. The functional module 11 writes the processing results into the memory 23, and the routing module 12 references the memory 23.

Specifically, in the configuration in FIG. 5(b), the server 92 includes the functional module 11, a memory 23-1, and the physical IFs 25-1 and 25-2, the server 93 includes the routing module 12, a memory 23-2, and physical IFs 35-1 and 35-2, and the physical IF 25-2 and the physical IF 35-1 are connected to each other. The functional module 11 writes the processing results into the memory 23-1, and the server 93 directly references the memory 23-1 through RDMA (Remote Direct Memory Access) etc, and writes the processing results into the memory 23-2. The routing module 12 acquires the processing results from the functional module 11 by referencing the memory 23-2.

The order of connection, between the routing module 12 and the functional module 11, where an OpenFlow switch module is used for the functional module 11 will be described below.

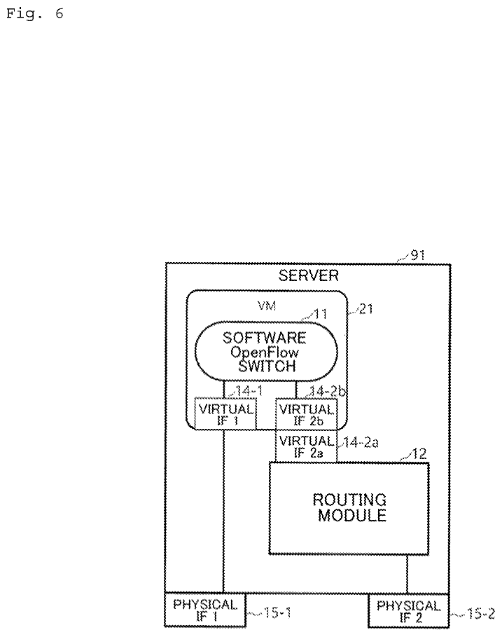

FIG. 6 illustrates an example of the pre-routing configuration in which the functional module 11 is disposed before the routing module 12. A packet processed by the functional module 11 on the virtual machine 21 is forwarded to the routing module 12.

FIG. 6 illustrates an example in which a software OpenFlow switch is activated in the pre-routing configuration.
A packet received by the physical IF 15-1 flows into the virtual IF 14-1, which is directly coupled thereto, to be subjected to OpenFlow processing.
By default, the packet is forwarded to the routing module 12 through the virtual IF 14-2b. Rewriting header, duplication, discard of the packet, rate control, and access control can be set as Flow rules for the OpenFlow processing.
The routing module 12 forwards the packet in accordance with routing.

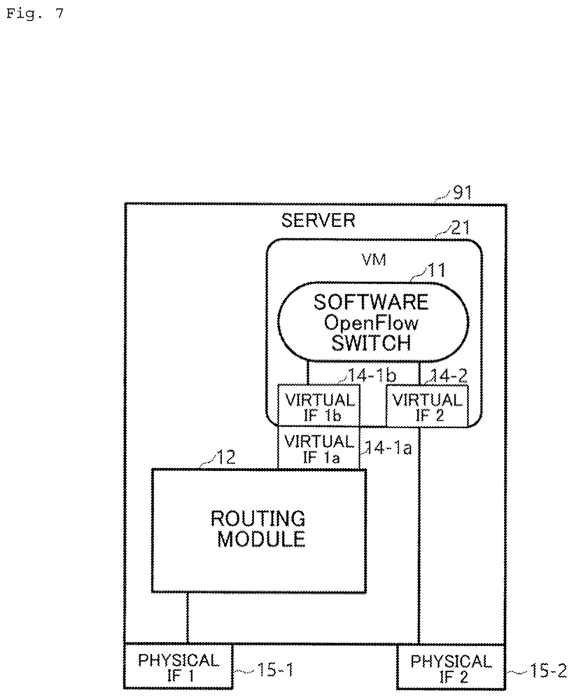

FIG. 7 illustrates an example of the post-routing configuration in which the functional module is disposed after routing. A packet that has been subjected to routing by the routing module 12 is processed by the functional module 11 on the virtual machine 21.

FIG. 7 illustrates an example in which a software OpenFlow switch is activated in the post-routing configuration.

A packet received by the physical IF 15-1 is subjected to routing by the routing module 12, and forwarded to a virtual IF 14-1b of the virtual machine 21 with the destination MAC address of appropriate NextHop attached thereto.

The virtual machine 21 executes OpenFlow processing. By default, the packet is forwarded from the virtual IF 14-1b to the virtual IF 14-2, and sent out from the physical IF 15-2 which is directly coupled thereto. Rewriting, duplication, discard of the packet header, rate control, and access control can be set as Flow rules for the OpenFlow processing.

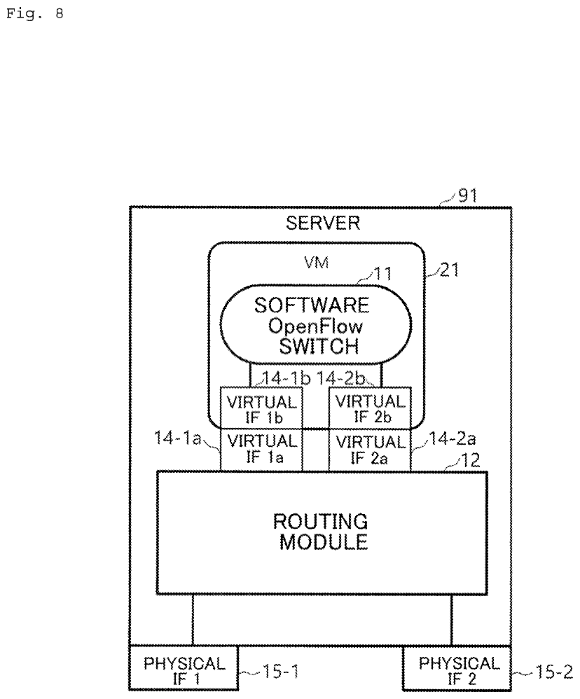

FIG. 8 illustrates an example of the intra-routing configuration in which the functional module 11 is disposed in the course of routing. A packet to be forwarded to the functional module 11 is controlled using a routing table of the routing module 12. While two virtual IFs are assigned on the virtual machine 21 in FIG. 8, one virtual IF may be assigned. In that example, it is necessary that the functional module 11 on the virtual machine 21 should return the packet.

FIG. 8 illustrates an example in which a software OpenFlow switch is activated in the intra-routing configuration.

The software OpenFlow switch on the virtual machine 21 is IP reachable (can respond to ARP (Address Resolution Protocol)) for both the virtual IF 14-1b and the virtual IF 14-2b.
A packet received by the physical IF 15-1 is subjected to routing by the routing module 12. When OpenFlow processing is aimed to be performed on a specific packet, the config module 13 makes settings for routing to the virtual IF 14-1b.
The virtual machine 21 executes OpenFlow processing. By default, the packet is forwarded from the virtual IF 14-1b to the virtual IF 14-2b, and forwarded to the virtual IF 14-2a. Therefore, the virtual machine 21 transmits the packet with the destination MAC in the packet header rewritten to the virtual IF 14-2a and with the source MAC rewritten to the virtual IF 14-2b. Rewriting, duplication, discard of the packet header, rate control, and access control can be set as Flow rules.

### Effects of the Invention

### (1) Module-Type Router System

A router system in which an existing application is incorporated can be constructed easily, since the functional module 11 is connectable to the routing module 12 through various configurations. Each developer of the router system can concentrate on developing either the routing module 12 or the functional module 11. It is possible to divide work, e.g. preparing a self-made functional module 11 while making use of an existing routing module 12, which enables immediate development and partial update.

(2) Order of Connection Between Routing Module 12 and Functional Module 11

A router system specifically for a desired use case can be configured by designating the connection of the functional module 11 from before, during, or after routing. The following indicates use case examples.

pre-routing: routing is performed after execution of an in-line security inspection such as IDS.

intra-routing: routing is performed with a specific packet encrypted by originally implemented encryption OSS (Open Source Software) such as WireGuard.

post-routing: a packet for a specific destination is unicast copied by the OpenFlow switch.

(3) OpenFlow Switch Module

A flexible packet operation is enabled by matching through 5-tuple and actions through duplication, discard, and rewriting for a case where an action is aimed to be executed on a packet that matches specific rules during routing.

### INDUSTRIAL APPLICABILITY

The present disclosure is applicable to the information communication industry.

### REFERENCE SIGNS LIST

11 Functional module
12 Routing module
13 Config module
14-1, 14-1a, 14-1b, 14-2a, 14-2b Virtual interface
15, 25-1, 25-2, 35-1, 35-2 Physical interface
21 Virtual machine
22 Container
23, 23-1, 23-2 Memory
91, 92, 93 Server

1. A router device comprising:
a routing module that performs a routing process on a packet;
a functional module that executes any operation on the packet subjected to the routing process performed by the routing module; and
a config module that sets a communication path that connects between the routing module and the functional module.

2. The router device according to claim 1, wherein
the functional module is an OpenFlow switch module.

3. The router device according to claim 1, wherein:
the routing module includes a virtual interface and the functional module includes a virtual interface; and
the communication path between the routing module and the functional module is formed using the virtual interfaces of the routing module and the functional module.

4. The router device according to claim 1, further comprising
a memory that is accessible from the routing module and the functional module, wherein
the communication path between the routing module and the functional module is formed using the memory.

5. A packet transfer method comprising:
setting a communication path, using a config module, that connects between a routing module and a functional module;
performing a routing process using the routing module on a packet that has flowed into a router device;
executing any operation using the functional module on the packet that has flowed into the router device; and
forwarding the packet between the routing module and the functional module using the communication path.

6. A storage medium containing a packet transfer program for causing a computer to implement functions of the router device according to claim 1.
